(19) United States
(12) Patent Application Publication
(10) Pub. No.: US 2026/0200704 A1
(43) Pub. Date: Jul. 16, 2026

(54) PLATFORM FOR AN ELEVATOR SYSTEM FOR A BUILDING WHICH IS UNDER CONSTRUCTION

(71) Applicant: INVENTIO AG, Hergiswil (CH)

(72) Inventor: Gabriele Bizzozero, Neuenkirch (CH)

(21) Appl. No.: 19/138,172

(22) PCT Filed: Dec. 6, 2023
(86) PCT No.: PCT/EP2023/084548

§ 371 Date: Jun. 12, 2025

(30) Foreign Application Priority Data
Dec. 19, 2022 (EP) 22214473.5

(51) Int. Cl. B66B 19/00; B66B 19/02; B66B 19/04

(52) U.S. Cl. CPC B66B 19/005; B66B 19/02; B66B 19/04

(57) ABSTRACT

An elevator system for a building under construction, the building having an elevator shaft that becomes higher as the building height increases during the construction phase of the building, includes a platform installed in the elevator shaft, which platform can be adapted to the increasing building height. The platform is supported on support brackets arranged in the elevator shaft and fixed to a shaft wall by anchor screws. Securing brackets are arranged in the elevator shaft and fixed to the shaft wall by anchor screws. The platform has holding devices that are pivotally fastened to the platform and which are connected to the securing brackets to secure the platform from falling.

### FIELD

The invention relates to a platform for an elevator system comprising an elevator shaft which becomes higher as the building height increases during the construction phase of the building. This elevator system can be used in particular on high-rise construction sites.

### BACKGROUND

During the construction of the building, the lower floors created first can be finished to such an extent that they are already habitable or usable for other purposes. For this purpose, the elevator system comprises an elevator car with which the floors already used as residential or business premises can be accessed during the construction phase of the building. In this case, the construction phase elevator having this elevator car grows with the building, so to speak, i.e., the usable lifting height of the construction elevator grows as the height of the building or elevator shaft increases. This makes it possible for construction workers and building materials or optionally users of apartments or business premises already occupied before the building is finished to be conveyed with the construction-phase elevator car during the construction period of the building. Such an elevator system is known from US 2016/0152442 A1. The elevator system has a machine platform that can be moved along the elevator shaft and from which the elevator car is suspended via support means arranged in the elevator shaft. The machine platform is in each case lifted in order to increase the usable lifting height of the elevator car in the elevator shaft. To lift the machine platform, a platform is provided that can be moved along the elevator shaft to form a support structure, which can be supported on the wall of the elevator shaft. This support structure arranged above the machine platform is in each case raised to a height at which the platform carried by this support structure can be lifted a certain distance by means of a first lifting device installed in the upper region of the elevator shaft before the machine platform is lifted. A second lifting device, which is arranged on the aforementioned support structure, is used to lift the machine platform. With the above-mentioned prior art, the elevator car from the construction phase can continue to be used for normal use of the building after completion of the building.

The erection of elevator shafts in buildings may be done using such climbing formwork. Climbing formworks are part of the discontinuous formwork systems and are used to manufacture tower-like structures. It can be used to create concrete portions for the elevator shaft floor by floor. It is known that pocket-like recesses are provided when creating the concrete portions. Extendable support means of the machine platform or support means of other platforms engage in these recesses in the shaft wall, thus enabling the respective platform to be positioned in a fixed location. This is shown, for example, in WO2022/069316 A1. However, it has been found in practice that, for example, when using climbing formwork, often no such recesses are made in the shaft wall or that recesses are in the wrong positions.

### SUMMARY

It is an object of the present invention to overcome the disadvantages of what is known and in particular to create an elevator system of the type mentioned at the outset, which can be erected simply and nonetheless safely in an elevator shaft. The elevator system should comprise a platform that can be reliably and safely positioned in the elevator shaft, also without special structural measures.

According to the invention, these and other objects are achieved with a platform having the features described herein. The elevator system for a building under construction with an elevator shaft that becomes higher as the building height increases during the construction phase of the building comprises a platform installed in the elevator shaft that is adapted or adaptable to the increasing building height. In this case, the elevator system can have one or more such platforms. For example, the platform can be a so-called machine platform, i.e., a platform with an elevator drive with which an elevator car suspended from the machine platform via support means can be driven. The machine platform can be lifted using a lifting device in the elevator shaft and thus adapted to the increasing building height. The platform may have support means for supporting the elevator shaft, for example telescopically retractable and extendable support means or pivotable support means. In the present document, the term “elevator shaft” should be understood to mean a space in a building under construction, the height of which increases in accordance with the construction progress, wherein the space is dimensioned and configured such that at least one elevator car of an elevator, usually an elevator car and a counterweight of one elevator each, can move upward and downward along vertical tracks in the space. Such an elevator shaft can be a single shaft enclosed by shaft walls. However, the elevator shaft can also be part of a continuous space, in which part the tracks of the elevator car and, if applicable, the counterweight of one of the at least two elevators arranged parallel to one another are arranged in each case, wherein there is no shaft wall between the tracks of adjacent elevators but usually steel beams for attaching elevator components.

Because at least one support bracket is arranged in the elevator shaft, which is fixed to a shaft wall of the elevator shaft by means of anchor screws, bolts or other fastening means, on which support bracket the platform is supported, and because a securing element is arranged for defining a shaft-side fixed point, which is fixed to a shaft wall of the elevator shaft by means of anchor screws, bolts or other fastening means, securing means being connected or connectable to the securing element to secure the platform, the platform can also be reliably and safely positioned in a fixed position in the elevator shaft, for example on a smooth shaft wall or elevator shafts that have not been specially prepared by structural measures during concrete formwork construction. The at least one support bracket can be arranged at least temporarily for the construction phase and in particular for a portion of the construction phase which lies between two lifting operations for a rail installation phase. However, the at least one support bracket could also be permanently arranged in the elevator shaft and does not have to be removed after the platform has been raised. The respective support bracket may preferably be a metal support bracket for forming a stable shaft abutment. The same may also apply to the at least one securing element. The securing element can also be arranged in the elevator shaft either temporarily or permanently. Securing means for securing the platform against a fall are temporarily attached to this securing element or are connected or connectable to it in some other way. The securing means thus work together with the securing element to secure the platform against falling. The securing element, e.g., a hook, eyelet screw or bolt, provides a fixed point on the shaft side, to which a safety rope or chain is attached as a securing means, for example by hooking it in. As soon as the platform moves downwards in an extraordinary situation (event of a securing operation), for example if the support bracket fails, the safety rope or safety chain is used to prevent a fall.

Alternatively or in addition to the aforementioned machine platform, the elevator system may also include other platforms that are positioned and secured in the elevator shaft in the manner described above. The platform can, for example, be a lifting platform whose purpose is to move the machine platform upwards for a lifting operation. Such a lifting platform is known as an upper protective platform (crash deck). The platform may further comprise, for example, a protective roof. The platform may then comprise a base component which forms a support structure, which base component is adapted to the shaft space and almost completely fills it in a plan view. This base component can be configured as a plate or comprise a plate. When the base component is installed or during the construction phase, it is preferably oriented horizontally.

According to a preferred embodiment, the securing element can in each case be designed as a securing bracket. The securing bracket can be easily fixed to the shaft wall, also meets high safety requirements, and thus provides an advantageous shaft-side fixed point for the securing means.

Preferably, two support brackets and two securing brackets can be provided on each side for supporting and securing the platform. In this case, these components can particularly preferably be arranged in pairs in the elevator shaft, one support bracket and one securing bracket in each case forming such a support and securing pair. Such an arrangement ensures a particularly stable and secure stationary positioning of the platform in the elevator shaft.

If the platform preferably has telescopically retractable and extendable support means or pivotable support means for supporting, the support bracket has lateral holders, in particular in the form of side plates, for securing the support means in position. For example, a metal profile part can be used as support means, which is displaceably mounted in a horizontal beam so that it can be retracted and extended in the manner of a telescope. Thanks to such brackets, a stable fit of the platform in its fixed position is ensured. For a lifting operation, the support means can be retracted or pivoted in, allowing the platform to be moved upwards without any problems. After the lifting operation has been completed, the support means can be extended or pivoted out again and the platform can then be lowered over the support means onto the upper support bracket(s) to create the new fixed position in the elevator shaft.

The support bracket can have a preferably plate-shaped fastening portion which lies or can be placed flat against the shaft wall, and an abutment portion projecting at right angles away from the fastening portion for fixing a support surface for the platform and in particular for the aforementioned support means. The fastening portion on the one hand and the abutment portion on the other hand can be metal parts, in particular made of steel. However, a one-piece design is also conceivable, in which the fastening portion and the abutment portion are formed together and form a monolithic body, for example a cast metal body.

In a preferred embodiment of the elevator system, the securing element is designed as a securing bracket and the platform has at least one holding device for forming securing means, which can be brought into operative connection with or interacts with the securing bracket to secure the platform. In this case, the securing bracket can form a stop for the holding device. If the platform moves downwards or wants to move in the event of a securing operation, there will be a striking contact between the holding device and the securing bracket, making a fall impossible. If two securing brackets are provided on each side, two holding devices must be provided to secure the platform.

The holding device may be pivotally fastened on the platform. The pivotable design allows the operative connection to be easily released for a lifting operation. The holding device can be pivoted back and forth between an active position (platform secured) and a second position in which the holding device is removed or separated from the securing bracket for the lifting operation, to release the operative connection.

The holding device can have an engagement opening which, in an active position, surrounds an abutment of the securing bracket, so that in the case of a securing operation the abutment forms a stop for the holding device to prevent a further downward movement of the platform.

The holding device can have a holding arm and a holding portion adjoining it, the holding device being pivotally mounted on the platform via a lower end of the holding arm and the holding portion adjoining an upper end of the holding arm, which holding portion is designed in the manner of a frame and forms the engagement opening. In its active position, the holding device can be held in the securing bracket in such a way that engagement is ensured via the engagement opening.

The holding device comprising the holding arm and holding portion can be made of one or more metal plates.

To further increase safety, position securing means may be provided to hold the holding device in the securing bracket, thereby ensuring engagement and thus securing the holding device in the active position.

An advantageous elevator system is achieved when the support bracket is positioned below the platform and the securing element, in particular the securing bracket, is positioned above the platform. This arrangement results in a particularly stable positioning, while the securing means are easy to handle.

It is further advantageous if the support bracket(s) and securing bracket(s) are essentially of the same type and preferably identical in design. Reducing different components results in advantages in terms of assembly and costs. The same component can be used either as a support bracket or as a securing bracket, which also has logistical advantages.

A further aspect of the invention relates to a platform for an elevator system for a building under construction with an elevator shaft which becomes higher as the building height increases during the construction phase of the building, a usable lifting height of the elevator system being adapted to the increasing building height using platforms, and in particular for the elevator system described above, at least one of these platforms having support means that can be retracted and extended in a preferably telescopic manner or pivotable support means for supporting on at least one support bracket, and that the platform has a holding device which can be brought into operative connection with a securing bracket to secure the platform.

Finally, a further aspect of the invention relates to a method for erecting an elevator system for a building under construction having an elevator shaft which becomes higher as the building height increases during the construction phase of the building, a usable lifting height of the elevator system being adapted to an increasing height of the building by carrying out at least one lifting operation, during which lifting operation for example a machine platform with an elevator drive and an elevator car suspended from the machine platform via support means are lifted in the elevator shaft by means of a lifting device. The method is characterized in that after a lifting operation, the machine platform is installed on at least one side on a smooth shaft wall of the elevator shaft in such a way that the machine platform is placed on at least one support bracket fixed to the shaft wall by means of anchor screws, bolts or other fastening means and that at least one securing bracket is fixed to the shaft wall by means of anchor screws, bolts or other fastening means and the machine platform is secured by means of the at least one securing bracket. In this case, “smooth” refers to a region of the wall where the platform is to be installed; the wall does not have to be completely smooth, of course. Smooth means that the wall has a more or less flat surface and, at least in the desired installation region for the platform, it does not have any indentations or notches in the wall into which support means can be inserted, as is otherwise usual according to the prior art. In this case, this method is particularly suitable for erecting the elevator system described above.

### DESCRIPTION OF THE DRAWINGS

Additional advantages and individual features of the invention are derived from the following description of an embodiment and from the drawings, in which:

FIG. 1 is a schematic side view of an elevator system for a building under construction with an elevator shaft that becomes higher as the building height increases during the construction phase, the elevator system comprising a machine platform fixedly positioned in the elevator shaft,

FIG. 2 is an enlarged detailed view of a portion of the elevator system of FIG. 1 with the machine platform securely positioned in the elevator shaft and fixed in position, by means of a support bracket and securing bracket,

FIG. 3 is a perspective view of a machine platform fixedly positioned in an elevator shaft for an elevator system according to the invention,

FIG. 4 is an enlarged view of a support bracket or securing bracket for the elevator system according to FIG. 3, and

FIG. 5 shows a holding device for securing the machine platform of the elevator system according to FIG. 3.

### DETAILED DESCRIPTION

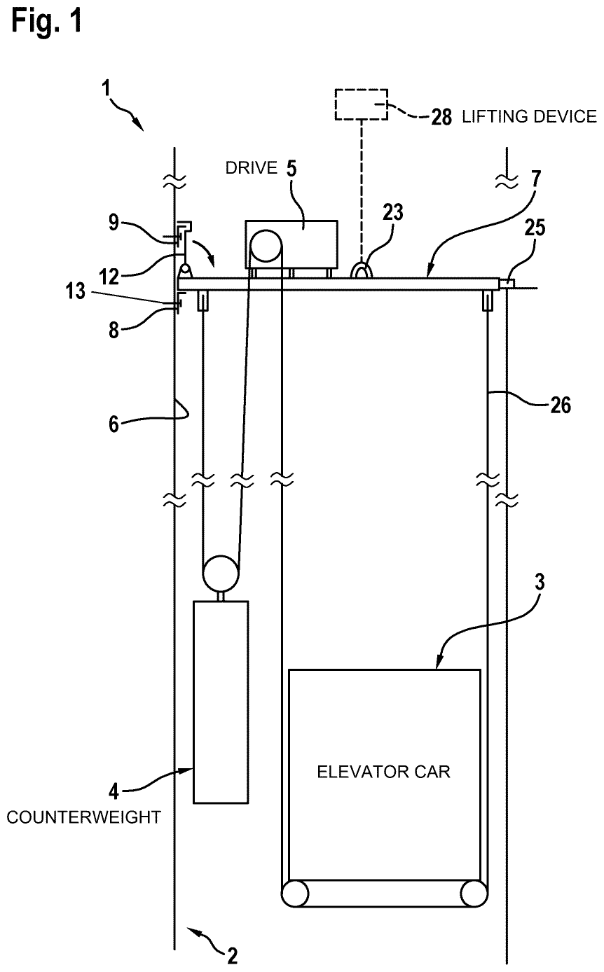

FIG. 1 schematically shows an elevator system 1 for a building which is under construction. The building comprises an elevator shaft 2 that becomes taller as the building height increases during the construction phase. An elevator car 3 is installed in the elevator shaft 2. The elevator also has a counterweight 4 and support means 26. During vertical travel, the elevator car 3 and a counterweight 4 are guided on guide rail strands (not shown here for simplicity). A drive 5 (e.g., traction sheave drive) drives the respective support means 26 (e.g., one or more belts, steel cables) and thus moves the elevator car 2 and the counterweight 4 in opposite directions. The elevator car 3 allows the transport of persons and goods to and from the lower floors even during the construction phase of the building. In particular, the elevator car can be used to transport construction workers and building materials. However, users of apartments or business premises already occupied before the building is finished can also be conveyed between at least the floors associated with these spaces in compliance with the regulations.

The elevator system 1 has a machine platform 7 with the aforementioned drive 5, on which the elevator car 3 is suspended via the support means 26. The machine platform 7 can be moved upwards along the elevator shaft 2 during the construction phase. In FIG. 1, the machine platform 7 is fixedly positioned in the elevator shaft 2 in a manner explained in detail below. In this case, however, the fixed positioning is only temporary; the elevator system grows discontinuously. The fixed positioning must be removed, so that a lifting operation can be carried out. During the lifting operation, the machine platform 7 is lifted to the next higher level in the elevator shaft 2.

Above the machine platform 7, the elevator system 1 has an arrangement (not shown here) for equipping the upward-growing elevator shaft 2 in particular with guide rails for the guide rail strand. In addition to the machine platform 7, this arrangement also comprises further platforms, such as an upper protective platform (not shown), over or by means of which the machine platform 7 can be lifted in the elevator shaft 2. For lifting purposes, a lifting device indicated by 28 and associated with the upper protective platform can be used. The upper protective platform also serves to support a mounting platform (also not shown). In this case, the mounting platform is the platform from which the guide rail strand(s) is/are extended upward. The mounting platform serves as a working platform for assembly personnel. The upper protective platform also has the task of protecting persons and equipment in the elevator shaft 2—in particular in the aforementioned mounting platform—from objects that could fall down during the construction work that takes place on the building. A growth phase can follow the rail assembly phase. After completion of the rail assembly phase and after the elevator shaft 2 has become sufficiently taller as the construction of the building progresses, the platforms must be positioned at a next higher level. After the upper protective platform has been temporarily fixed again in the elevator shaft 2, the machine platform 7 can be lifted to the next higher level. In the present embodiment, the machine platform 7 has a connection point, by way of example in the form of an eyelet 23, for hanging, for example, a chain hoist. The chain hoist is adapted such that the machine platform 7, preferably together with the attached elevator car 3 (and the counterweight 4), can be moved upward for a lifting operation. However, the machine platform 7 could also be moved to the upper operating position by means of other lifting means such as a crane, winch, hydraulic jack or strand jack.

As can be seen from FIG. 1, the machine platform 7 is supported on one side on a support bracket designated 8. The shaft openings are located on the opposite side. On this side, the machine platform 7 is supported on the floor of the story, a movable support means 25 in the form of a profile part being provided, which provides the support. This support means 25 can be moved or removed if necessary such that the machine platform 7 can be moved upwards for an obstacle-free lifting operation. A support bracket 8 is fixed to a shaft wall 6 of the elevator shaft 2 by means of anchor screws 13, bolts or other fastening means. There is a second bracket above it. This bracket, designated 9, serves to secure the machine platform 7 and is therefore referred to below as the securing bracket 9. The securing bracket 9 provides a fixed point on the shaft side, with which a holding device 12 pivotally fastened to the platform 7 interacts.

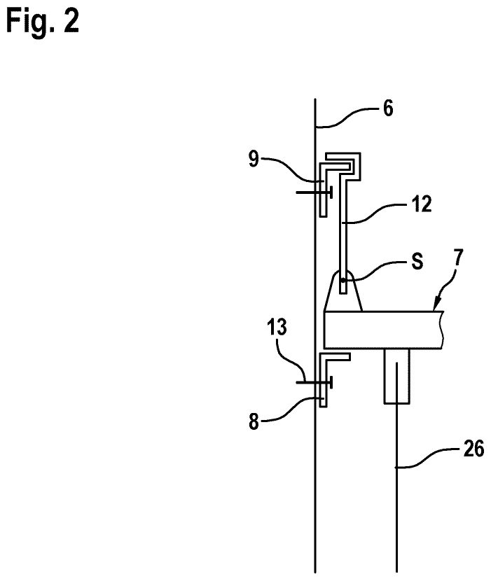

In FIG. 2, details of the mentioned holding device 12 can be seen. The holding device 12 has a hook-like engagement structure which, in the case of a securing operation as a result of the failure of the support bracket 8, comes to a stop on the securing bracket 9 and thus stops an undesired downward movement of the machine platform 7. Instead of a securing bracket 9, other securing elements such as hooks, eyelet screws or bolts inserted into the shaft wall 6 to provide a fixed point on the shaft side could also be conceivable. Instead of a holding device 12, other securing means could also be used. For example, to secure the platform 7 from falling, a safety rope or chain could be temporarily connected to the aforementioned shaft-side fixed point.

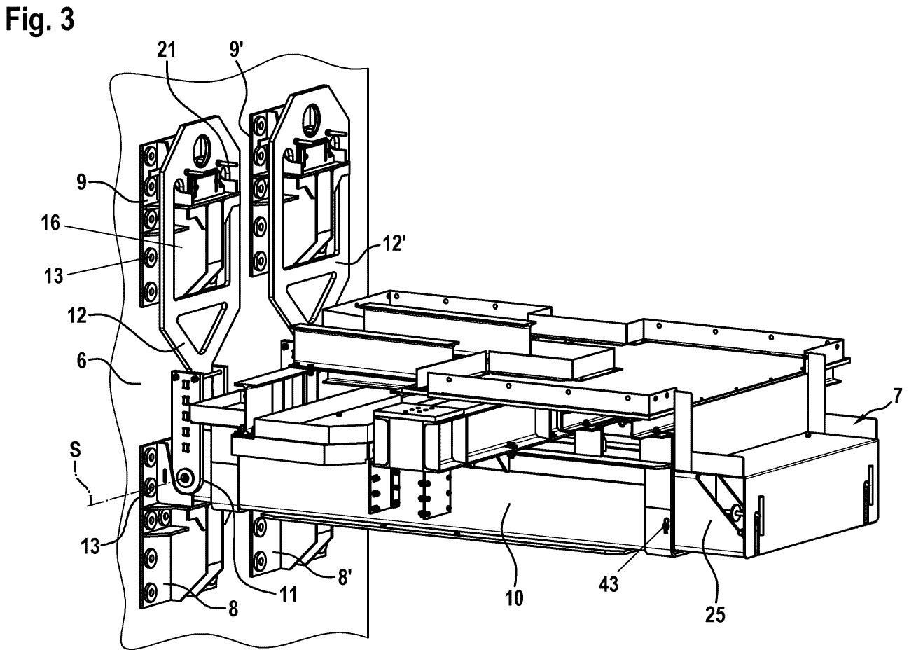

FIG. 3 to 5 relate to a further embodiment of an elevator system for a building under construction with an elevator shaft that becomes higher as the building height increases during the construction phase of the building, in which elevator system at least one platform is held and secured in the elevator shaft in a similar manner, here, too, the platform being, by way of example, a machine platform 7, the drive for moving the elevator car not being shown in the present case. The machine platform 7 has two horizontal main beams 10 running parallel to each other. The beams 10 are equipped with movable support means 11, 25 at opposite ends. At the end facing the shaft wall 6, the machine platform 7 has telescopically extendable and retractable support means 11. These support means 11 are formed by profile parts which are displaceably mounted in the beams 10 designed as longitudinal beams, the longitudinal beams 10 being designed as box profiles in the present embodiment.

In FIG. 3 the support means 11 are in the extended state. It can be seen that the respective profile part for forming the support means lies on the support bracket 8 and thus supports the platform. The support bracket 8 is fixed to the shaft wall 6 by means of anchor screws 13. Above the support bracket 8, the securing bracket 9 is arranged, which is also fixed to the shaft wall 6 in a similar manner by means of anchor screws 13. Furthermore, it can be seen from FIG. 3 that on the side facing the shaft wall 6, two support brackets 8, 8′ and two securing brackets 9, 9′ are provided for supporting and securing the machine platform 7, which brackets are each combined in pairs.

In terms of their construction, in the present case the support brackets 8 and securing brackets 9 are identical. For the sake of simplicity, the structure and construction of the support bracket 8 is explained below. The statements regarding the support bracket 8 therefore also apply to the securing bracket 9. The support bracket 8 has a plate-shaped fastening portion 17 lying flat against the shaft wall 6, and an abutment portion 18 projecting at right angles from the fastening portion for defining a support surface.

The machine platform 7 has support means arranged at the ends of the longitudinal beams 10 opposite the shaft wall 6, the support means designated 25 being pivotally attached to the beam 10. The support means 25 which is fastened to the beam so as to be pivotable about the pivot axis 43 can be pivoted into the horizontal position shown in FIG. 3 and fixed in this position by means of a securing pin. The support means 25 can be prestressed, for example by means of springs (not shown), so that the support means 25 are pivoted out into the horizontal position under spring action. The machine platform 7 is fixedly positioned in the elevator shaft at the front via pivoted-out support means 25, in order to fix this position in the region of the front, the support means 25 being able to be firmly connected to the floor of the story for the required period using screws (not shown). Platforms could also be positioned in a fixed position using such pivoting support means with a smooth shaft wall, approximately analogously to the left-hand side or rear side where—as already described—telescopically movable support means are used instead of pivoting support means.

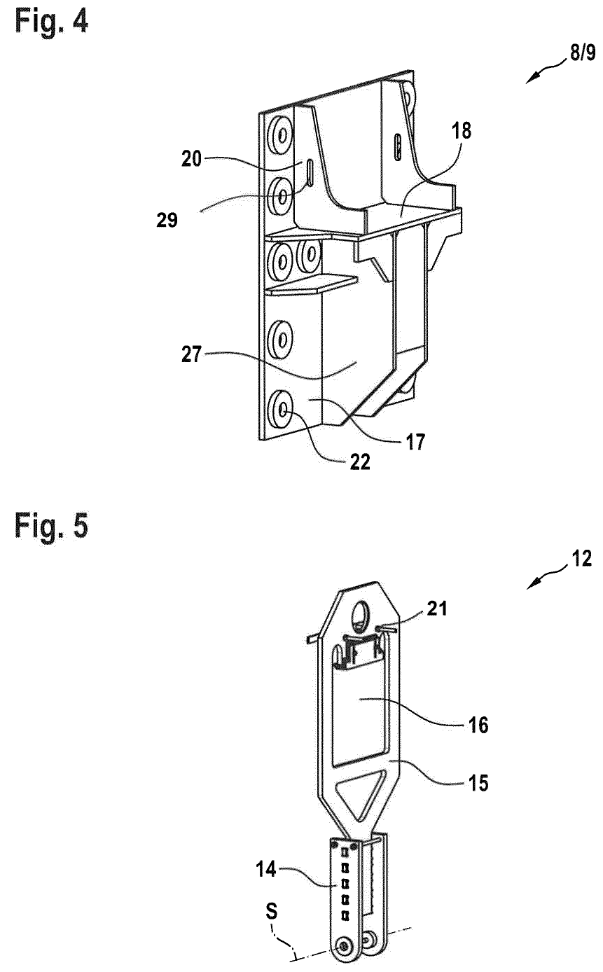

Structural details of the design of the support bracket 8 (or the identical securing bracket 9) can be seen in FIG. 4. By using components made of metal plates, a cost-effective yet very stable support bracket 8 can be produced. In the fastening portion 17 formed by a metal plate, a plurality of bores 22 are provided, into which the anchor screws can be passed. The abutment portion 18, which projects at right angles from the fastening portion 17, is rigidly connected to the fastening portion 17 via a plug connection and preferably by welding. To stiffen the construction, fastening ribs 27 are also provided, which support the abutment portion 18 downwards. Two side plates form lateral brackets 20 for securing the respective support means of the platform in position. The side plates 20 have leg portions on the front side which define contact surfaces in the event that the holding device 12 is lowered downwards in the event of a securing operation. In this case, the forces of the platform 7, which now rests on the securing bracket 9, are introduced into the securing bracket 9 via the side plates 20.

Structural details regarding the design of the holding device 12 can be seen in FIG. 5. The holding device 12 has a holding arm 14 and an adjoining holding portion 15, the holding device being constructed from a plurality of metal plates. The holding device 12 is pivotally attached to the platform 7, the pivot axis being indicated by S. The holding device 12 is pivotally mounted on the platform via a lower end of the holding arm 14. The holding portion 15 is designed like a frame and forms an engagement opening 16. In the active position shown in FIG. 3, the engagement opening 16 of the holding device 12 surrounds the abutment of the securing bracket 9, so that in the event of a securing operation the abutment forms a stop for the holding device 12 for preventing a further downward movement of the platform 7.

In FIG. 3, position securing means 21 can then be seen, which are provided to securely hold the holding device 12 in the securing bracket 9 in its active position, thereby ensuring the engagement and in order to secure the holding device 12. The fixed positioning must be removed so that a lifting operation can be carried out and the machine platform 7 can be lifted to the next higher level in the elevator shaft 2. For this lifting operation, the position securing means 21 are released by removal and the holding device 12 is pivoted downwards at least far enough that the holding device 12 no longer blocks the path with respect to the securing bracket 9 and an obstacle-free lifting of the machine platform 7 is made possible. The arrangement can be designed such that the holding device 12 can be pivoted into an approximately horizontal position.

The aforementioned position securing means 21 contain, as can be seen from FIG. 5, two threaded rods in the present embodiment, which are guided through bores in the holding portion 15. The threaded rods are secured at the front with nuts. The threaded rods are screwed to the rear with a flat profile which can be inserted into the securing bracket 9 via slots 29 in the side plates 20 (slots 29: see FIG. 4).

A lifting platform or crash deck, over which the machine platform 7 can be moved upwards, can also be equipped with similar holding devices and supported on support brackets in an analogous manner to the machine platform 7 and secured by means of the holding devices via securing brackets.

The method for erecting the elevator system 1 for a building under construction, comprising an elevator shaft 2 which becomes higher as the building height increases during the construction phase of the building, the usable lifting height of the elevator system 1 being adapted to the increasing height of the building, generally comprises a plurality of lifting operations that are carried out in the process. During the lifting operation, the machine platform 7 with the elevator drive 5 and the elevator car 3 suspended from the machine platform 7 via support means are lifted in the elevator shaft 2 by means of the lifting device 28. After the lifting operation, the machine platform 7 is installed on the smooth shaft wall 6 of the elevator shaft 2, for this installation process the machine platform 7 being set down on one side by means of support brackets 8, 8′ fixed to the shaft wall 6 by means of anchor screws 13. On the side opposite the shaft wall 6, the machine platform 7 can be placed on the floor of the story. On this side, the machine platform 7 could also be fixed in place in another way. It is also conceivable to use support brackets and securing brackets on two opposite sides of the elevator shaft in each case.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. An elevator system for a building under construction, the building including an elevator shaft that becomes higher as a building height increases during a construction phase of the building, the elevator system comprising:
a platform installed in the elevator shaft;
a support bracket arranged in the elevator shaft and fixed to a shaft wall of the elevator shaft by fastening means, the support bracket supporting an end of the platform;
a securing element arranged in the elevator shaft and fixed to the shaft wall of the elevator shaft by fastening means; and
securing means attached to the platform and adapted to connect to the securing element to secure the platform against downward movement in the elevator shaft.

17. The elevator system according to claim 16 wherein the securing element includes a securing bracket fixed to the shaft wall above the support bracket.

18. The elevator system according to claim 17 wherein the securing bracket and the support bracket are identical in shape.

19. The elevator system according to claim 16 wherein the support bracket is a pair of the support brackets spaced apart in a horizontal direction and the securing element is a pair of securing brackets fixed to the shaft wall side above the support brackets.

20. The elevator system according to claim 16 wherein the platform includes telescopically extendable and retractable support means and the support bracket includes lateral brackets securing the support means.

21. The elevator system according to claim 20 wherein the support bracket has a plate-shaped fastening portion placed flat against the shaft wall and an abutment portion projecting at right angles away from the fastening portion with a support surface supporting the platform support means.

22. The elevator system according to claim 16 wherein the securing element includes a securing bracket and the securing means includes a holding device movable into an operative connection with the securing bracket to secure the platform against downward movement in the elevator shaft.

23. The elevator system according to claim 22 wherein the holding device is pivotally fastened to the platform.

24. The elevator system according to claim 22 wherein the holding device has an engagement opening formed therein that surrounds an abutment of the securing bracket during the operative connection.

25. The elevator system according to claim 24 wherein the holding device includes a holding arm and a holding portion adjoining the holding arm, the holding device being pivotally mounted on the platform at a lower end of the holding arm and the holding portion adjoining an upper end of the holding arm, the holding portion having the engagement opening formed therein.

26. The elevator system according to claim 22 wherein the holding device includes a holding arm and holding portion formed from one or more metal plates.

27. The elevator system according to claim 22 wherein the securing means includes position securing means holding the holding device in the securing bracket.

28. The elevator system according to claim 16 wherein the support bracket is positioned below the platform and the securing element is positioned above the platform.

29. A platform for an elevator system for a building under construction, the building having an elevator shaft that becomes higher as a building height increases during a construction phase of the building, the platform comprising a holding device movable into operative connection with a securing bracket fixed to a shaft wall of the elevator shaft to secure the platform from downward movement in the elevator shaft when the platform is installed in the elevator shaft.

30. A method for erecting an elevator system for a building under construction, the building having an elevator shaft that becomes higher as a building height increases during a construction phase of the building, the method comprising steps of:
adapting a usable lifting height of the elevator system to the increasing height of the building by carrying out at least one lifting operation, the lifting operation lifting in the elevator shaft a machine platform with an elevator drive and an elevator car suspended from the machine platform by a support means using a lifting device;
after the lifting operation, installing the machine platform on a shaft wall of the elevator shaft by placing an end of the machine platform on a support bracket fixed to the shaft wall by fastening means; and
securing the machine platform by a securing bracket fixed to the shaft wall by fastening means.
